(19) United States
(12) Patent Application Publication
(10) Pub. No.: US 2005/0006377 A1
(43) Pub. Date: Jan. 13, 2005

(54) Woven electric heating element and process of making the same

(76) Inventor: Thomas Tsung-Chia Chen, Taichung City (TW)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/614,659

(22) Filed: Jul. 7, 2003

(51) Int. Cl. H05B 3/34; H05B 3/54

(52) U.S. Cl. 219/545; 219/542

(57) ABSTRACT

A woven electric heating element includes an electric heating sheet formed by weaving an electric heating wire and an insulating thread, and two heat-resistant insulating layers covering respectively two opposite surfaces of the electric heating sheet. In one preferred embodiment, the heating wire is formed into a plurality of conductive warp lines, and the insulating thread is woven weftwise on the warp lines. Two conductive clamp plates are respectively mounted on the heating sheet to position the warp lines.

### BACKGROUND OF THE INVENTION

1. Field of the Invention

The invention relates to an electric heating element, more particularly to a woven electric heating element and the process of making the same.

2. Description of the Related Art

Referring to FIG. 1, a conventional electric heating element 1, such as an electric heating sheet, includes a support plate 11, a thick electric heating wire 12, a thin electric heating wire 13, and two heat-resistant insulating plates 14.

The support plate 11 is made of mica material, and has spaced-apart toothed portions 111 located on upper and lower edges of the support plate 11, and a plurality of through holes 112, 113, 114 formed in two opposite end portions of the support plate 11.

The thick and thin electric heating wires 12, 13 have two ends conductively connected to a power source. First ends of the thick and thin electric heating wires 12, 13 are interconnected, and pass through the through holes 112 in the support plate 11. Second ends of the thick and thin electric heating wires 12, 13 are wound around the toothed portions 111, and extend respectively out of the through holes 113, 114. The main application of the thick electric heating wire 12 is for heating an electric water heater, whereas the thin electric heating wire 13 is for maintaining heat inside the water heater.

The heat-resistant insulating layers 14 are adhered respectively to two opposite surfaces of the support plate 11 so as to cover and insulate the thick and thin electric heating wires 12, 13.

Because the support plate 11 is made of mica material, which is brittle, the conventional electric heating element 1 has to be produced manually, thereby rendering the conventional electric heating element 1 inconvenient and slow to manufacture. Furthermore, different ratings of voltage, power, and dimension of the conventional electric heating element 1 require different molds for the support plate 11 so that the production cost is increased. In addition, preparation of the molds is time-consuming.

### SUMMARY OF THE INVENTION

Therefore, the object of the present invention is to provide a woven electric heating element and the process of making the same so as to overcome the aforementioned drawbacks of the prior art.

According to one aspect of this invention, a woven electric heating element comprises an electric heating sheet formed by weaving an electric heating wire and an insulating thread, and two heat-resistant insulating layers covering respectively two opposite surfaces of the electric heating sheet.

According to another aspect of this invention, a process for making a woven electric heating element includes the steps of weaving an electric heating wire with an insulating thread so as to form an electric heating sheet, and covering two opposite surfaces of the electric heating sheet with two heat-resistant insulating layers, respectively.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional electric heating element;

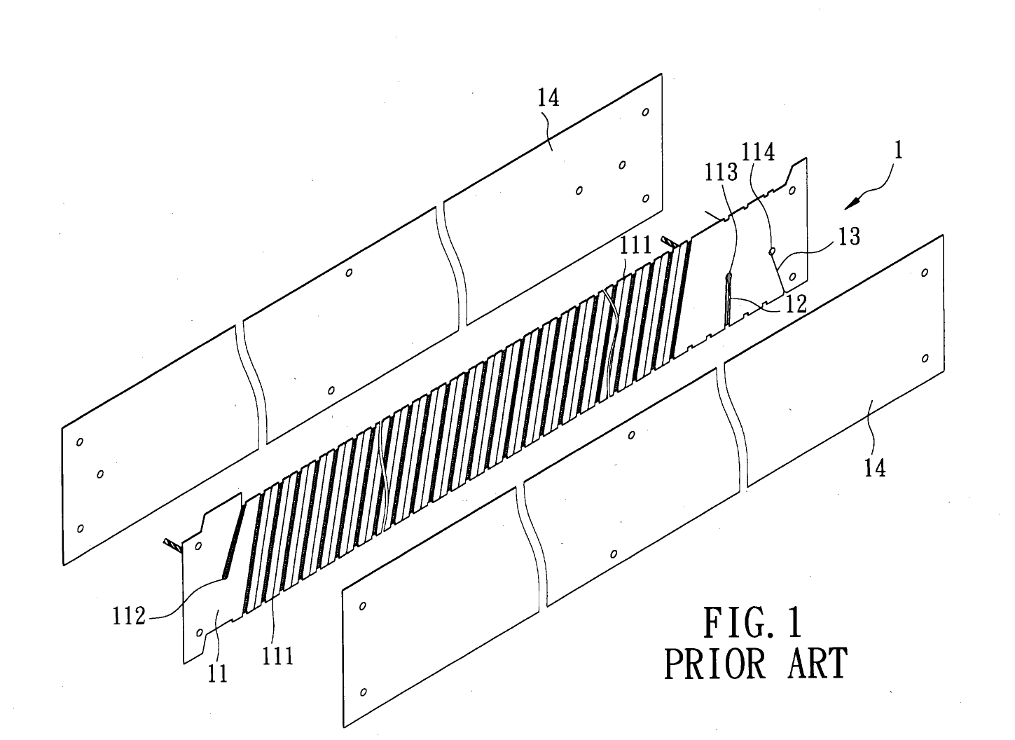

FIG. 2 is a flow chart illustrating the first preferred embodiment of the process of making a woven electric heating element according to the present invention;

FIG. 3 is a schematic view of the woven electric heating element of the first preferred embodiment, in which a portion is removed for the sake of clarity;

FIG. 4 is an exploded perspective view of the woven electric heating element of the first preferred embodiment;

FIG. 5 is an enlarged fragmentary perspective view of an electric heating sheet of the woven electric heating element of the first preferred embodiment;

FIG. 6 is a schematic view of the woven electric heating element of the first preferred embodiment, illustrating cut sections of the electric heating sheet connected in parallel;

FIG. 7 is a circuit diagram of FIG. 6;

FIG. 8 is an exploded perspective view of the second preferred embodiment of a woven electric heating element according to the present invention;

FIG. 9 is an enlarged fragmentary perspective view of an electric heating sheet of the second preferred embodiment;

FIG. 10 is a schematic view of the second preferred embodiment, illustrating cut sections of the electric heating sheet connected in series;

FIG. 11 is a circuit diagram of FIG. 10; and

FIG. 12 is a fragmentary perspective view of the third preferred embodiment of a woven electric heating element according to the present invention.

### DETAILED DESCRIPTION OF THE PREFERRED EMBODIMENTS

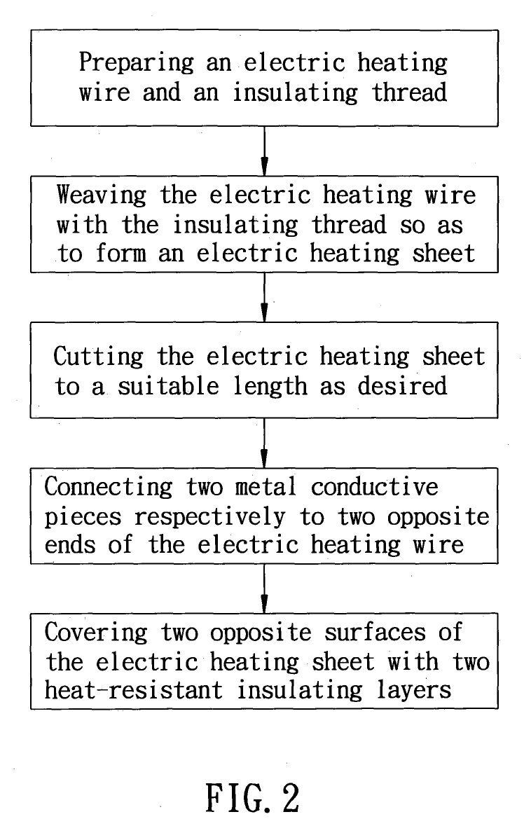

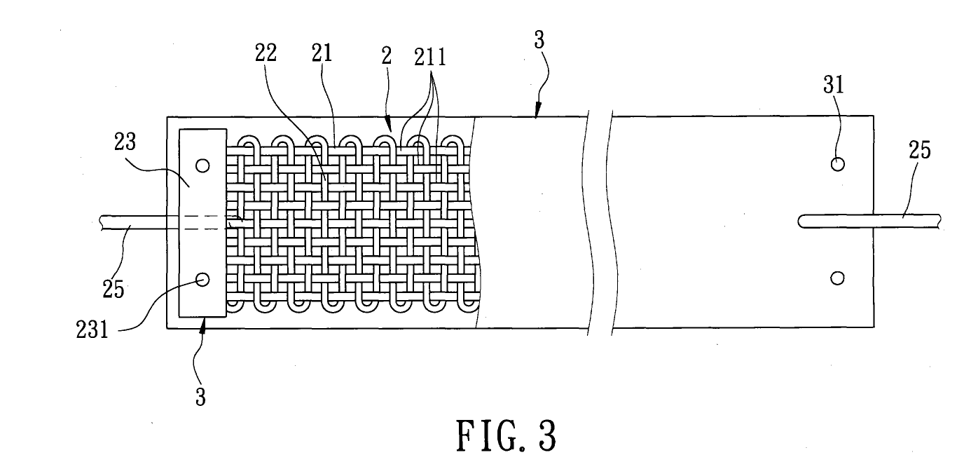

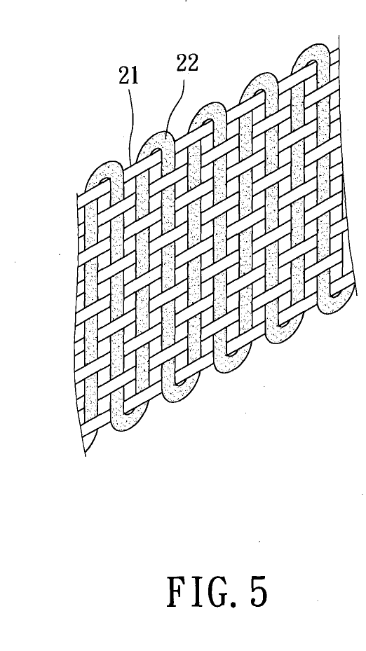

Referring to FIGS. 2 to 5, the first preferred embodiment of the process of making a woven electric heating element according to the present invention is shown to comprise the steps of preparing an electric heating wire 21 and an insulating thread 22, weaving the electric heating wire 21 with the insulating thread 22 by warping the electric heating wire 21 to form a plurality of conductive warp lines 211 and weaving weftwise the insulating thread 22 on the conductive warp lines 211 so as to form an electric heating sheet 2, cutting the electric heating sheet 2 to a desired length, preparing two metal conductive clamp plates 23, connecting the conductive clamp plates 23 respectively to two opposite ends of the conductive warp lines 211, and covering two opposite surfaces of the electric heating sheet 2 with two heat-resistant insulating layers 31, respectively.

The electric heating wire 21 used in this embodiment is made a rounded electric heating wire 21. However, a flat electric heating wire can also be used.

The metal conductive clamp plates 23 are mounted respectively on two opposite ends of the electric heating sheet 2 between the insulating layers 31 to position respectively two opposite ends of each conductive warp line 211.

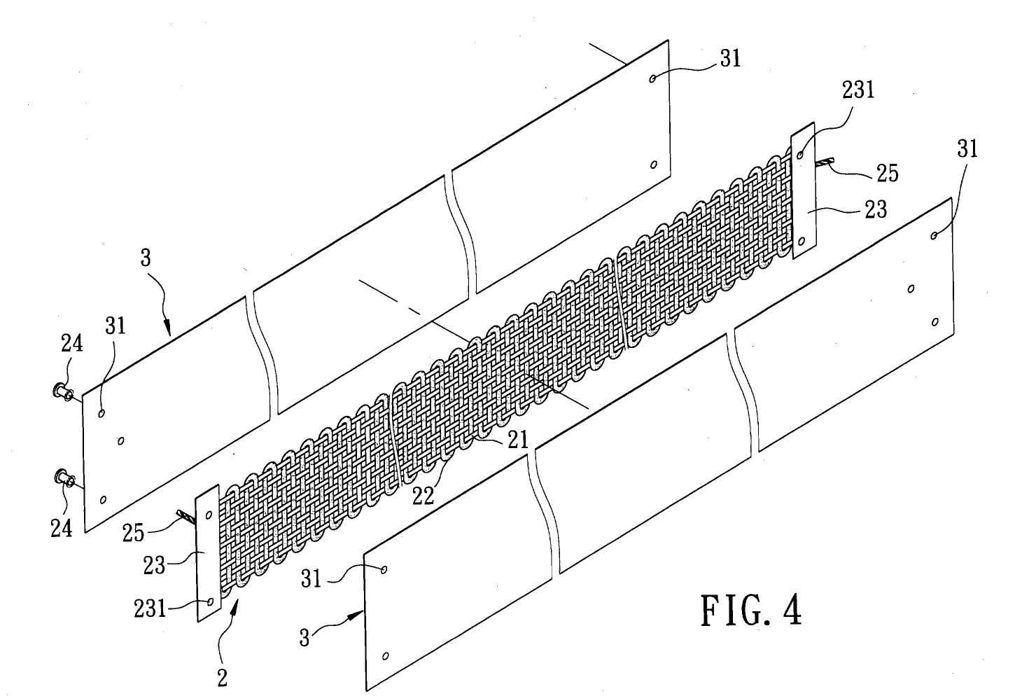

The heat-resistant insulating layers 3 and the conductive clamp plates 23 have two opposite ends formed respectively and correspondingly with a plurality of through holes 31, 231. The conductive clamp plates 23 are fastened between the heat-resistant insulating layers 3 by means of a plurality of rivets 24 (only two are shown in FIG. 4) that pass respectively through aligned ones of the through holes 31, 231. While the conductive warp lines 211 and the insulating thread 22 are shown in enlarged views in the figures as having substantial spacing therebetween to facilitate illustration, they are densely woven in their actual state.

In this embodiment, the opposite ends of the conductive warp lines 211 are clamped and pressed by the conductive clamp plates 23, respectively, so that the conductive warp lines 211 are placed in a parallel connection. Each end 25 of the electric heating wire 21 extends through a respective one of the conductive clamp plates 23 so as to connect with an external power source.

When the insulating thread 22 is woven on the electric heating wire 21 in a uniformly spaced-apart arrangement, since the insulating thread 22 is made of good heat-resistant fiberglass thread or ceramic fiber thread, the insulating thread 22 has a suitable degree of rigidity so that a support plate, which is used in the conventional electric heating element, is not required to support the electric heating wire 21. As such, the electric heating wire 21 of the present invention can be effectively positioned, contact between two adjacent conductive warp lines 211 can be avoided, and production of the electric heating element of the present invention is relatively easy and fast. Furthermore, with the use of a weaving machine, production efficiency of the electric heating sheet 2 of the electric heating element of the present invention can be increased, manpower cost can be minimized, and uniform and stable quality can be ensured.

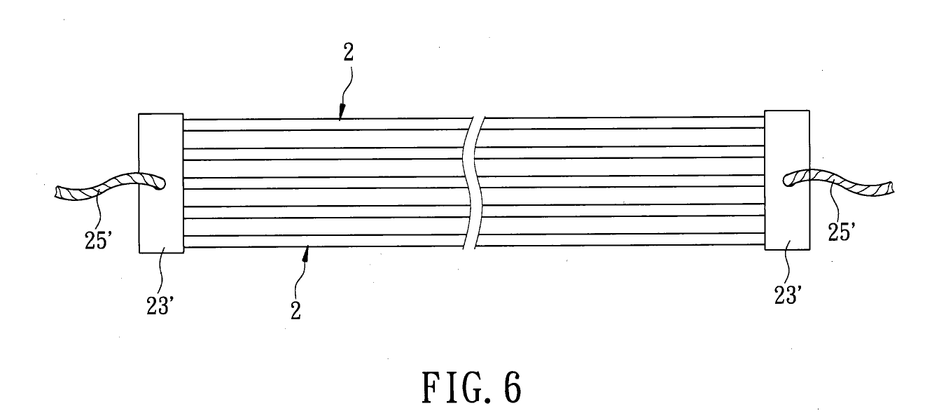

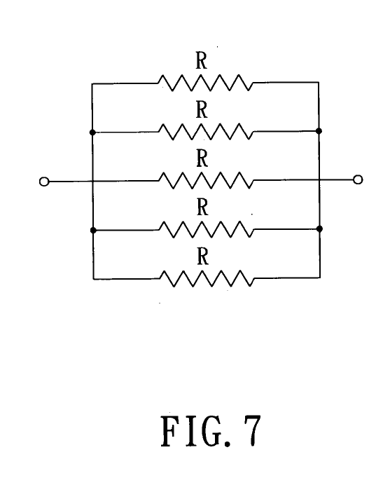

Since the electric heating wire 21 of the present invention is woven into an elongated sheet 2 (see FIG. 4), the electric heating sheet 2 can be cut into sections having a fixed surface area and/or a fixed length required to provide the desired rating of voltage, power, and dimension. Referring to FIGS. 6 and 7, two opposite ends of each cut section of the electric heating sheet 2 are connected respectively and electrically to two conductive clamp plates 23′ so that the cut sections are connected in parallel to form an electrical circuit shown in FIG. 7. Two connecting wires 25′ extend through the conductive clamp plates 23′ for connection with an external power source.

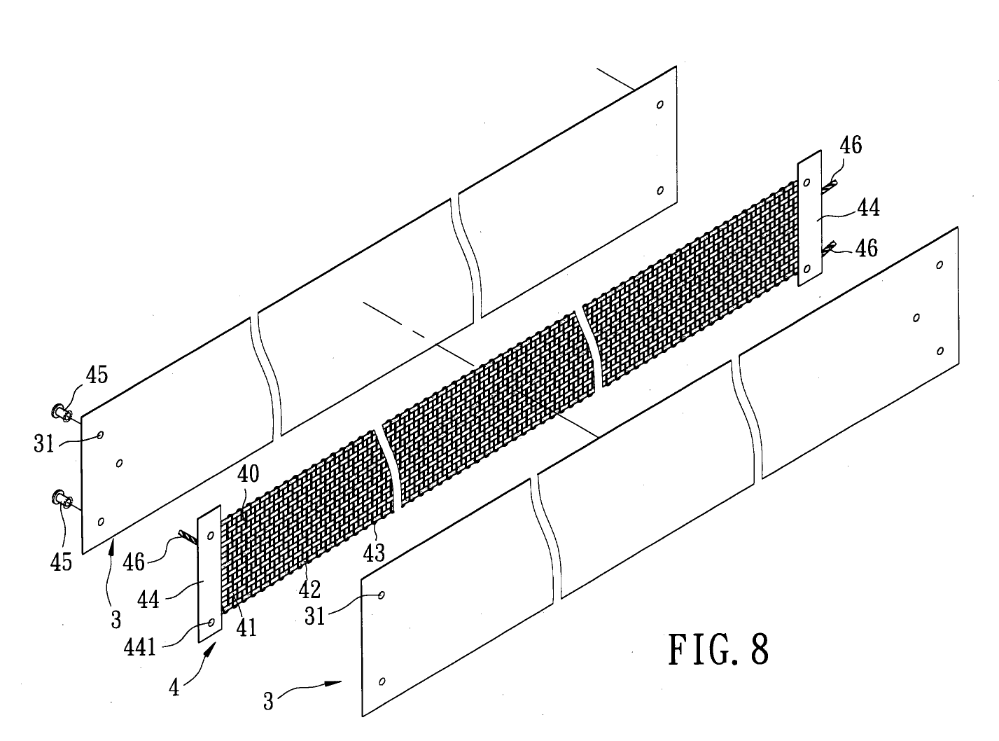

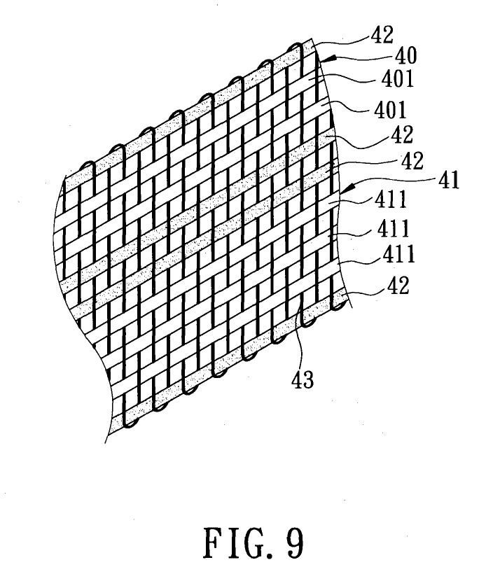

Referring to FIGS. 8 and 9, the second preferred embodiment of a woven electric heating element according to the present invention is shown to be substantially similar to the first preferred embodiment. However, in this embodiment, the electric heating element includes two first and second electric heating wires 40, 41, a plurality of coarse insulating warp yarns 42, and an insulating thread 43, which are woven to form an electric heating sheet 4. The electric heating element of the present invention further includes two conductive clamp plates 44 that are mounted respectively on two opposite ends of the electric heating sheet 4, and two heat-resistant insulating layers 3 covering respectively two opposite surfaces of the electric heating sheet 4. The heat-resistant insulating layers 3 and the conductive clamp plates 44 have two opposite ends formed respectively and correspondingly with a plurality of through holes 31, 441. The conductive clamp plates 44 are fastened between the heat-resistant insulating layers 3 by means of a plurality of rivets 45 (only two are shown in FIG. 8) that extend respectively through aligned ones of the through holes 31, 441. The insulating thread 43 in this embodiment is a fine thread.

The weaving process of the second preferred embodiment is accomplished by weaving the insulating thread 43 consecutively and weftwise on a warp composed of a coarse insulating warp yarn 42, two conductive warp lines 401 formed by warping the first electric heating wire 40, two coarse insulating warp yarns 42, three conductive warp lines 411 formed by warping the second electric heating wire 41, and a coarse insulating warp yarn 42 so as to form the electric heating sheet 4. The conductive warp lines 401 and 411 extend respectively on two sides of the insulating warp yarn 42. This kind of weaving process is suitable for an electric heating wire commonly used in an electric water heater. The three conductive warp lines 411 of the second electric heating wire 41 are used for heating the electric water heater. The two conductive warp lines 401 of the first electric heating wire 40 are used for maintaining heat inside the water heater. One end of the first electric heating wire 40 is connected to one end of the second electric heating wire 41, and is further connected to a connecting wire 46 for connection with an external power source. The other ends of the first and second electric heating wires 40, 41 are connected respectively to two connecting wires 46 for connection with the external power source.

In this embodiment, two insulating warp yarns 42 are disposed between adjacent conductive warp lines 401 and 411 of the first and second electric heating wires 40, 41 to effect isolation. The difference between the weaving process of the second preferred embodiment and that of the first preferred embodiment resides in that two insulating warp yarns 42 are disposed between the adjacent first and second electric heating wires 40, 41 so as to prevent occurrence of an electrical potential difference and to provide better weaving strength. Furthermore, the insulating thread 43 used in this embodiment is made of heat-resistant fiberglass thread or ceramic fiber thread, and is closely woven with the first and second electric heating wires 40, 41 and the insulating warp yarns 42 so that the first and second electric heating wires 40, 41 do not easily move relative to the insulating warp yarns 42.

Use of the electric heating sheet 4 is substantially similar to that of the first preferred embodiment. Particularly, like the electric heating sheet 2, the electric heating sheet 4 may be cut into sections, which are in turn interconnected electrically in parallel to obtain the desired rating of voltage, power, and dimension. Then, connecting wires and the conductive clamp plates are used to connect the electric heating sheet 4 to an external power source.

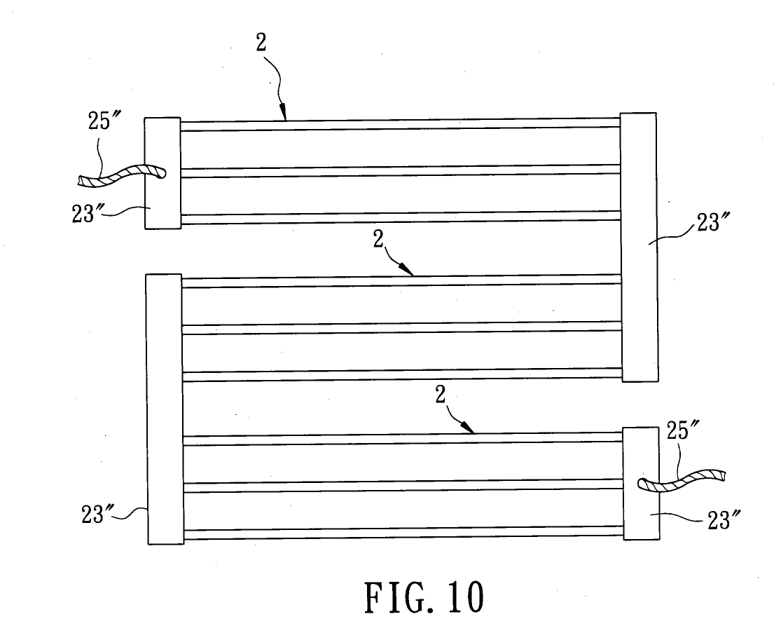

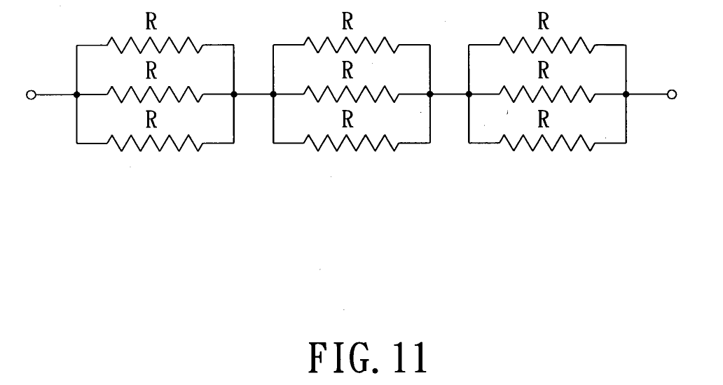

The cut sections of the electric heating sheet 2 can also be connected in series as shown in FIG. 10. Numeral 23″ represents conductive clamp plates to interconnect the ends of the cut sections of the electric heating sheet 2. Numeral 25″ represents connecting wires for connection with an external power source. The electrical circuit formed thereby is as shown in FIG. 11.

It should be noted that the electric heating sheets 2, 4 of the preferred embodiments may be formed with large mesh openings. The electric heating wire and the insulating warp yarn may also be woven with fine mesh openings using the aforementioned weaving process so as to obtain the desired rating of voltage, power, and dimension.

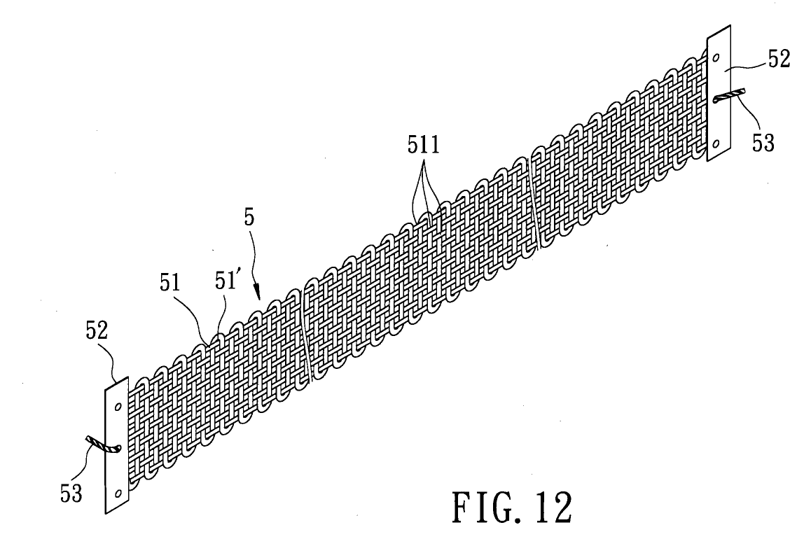

Referring to FIG. 12, the third preferred embodiment of a woven electric heating element according to the present invention is shown to be substantially similar to the first preferred embodiment. However, this embodiment includes two electric heating wires 51, 51′, one of which is warped to form a plurality of conductive warp lines 511, and the other one of which is woven weftwise on the conductive warp lines 511 so as to form an electric heating sheet 5, two conductive clamp plates 52 connected electrically and respectively to two opposite ends of the conductive warp lines 511, and two connecting wires 53 extending outwardly and respectively from the conductive clamp plates 52.

From the above description of the preferred embodiments, the advantages of the woven electric heating element and the process of making the same according to the present invention can be summarized as follows:

1. The electric heating sheet of the present invention is formed by weaving an electric heating wire and an insulating thread so that the electric heating sheet of the present invention does not require an additional support plate, and can be woven automatically using a weaving machine. As such, production of the electric heating sheet of the present invention is quick, quality is even, and stability is good.

2. Since the electric heating wire is woven into an electric heating sheet in the present invention, the electric heating sheet can be cut into different dimensions as desired to provide electric heating products with the required rating of voltage, power, and size. As such, the cost and time for preparing molds for the support plates needed in the conventional electric heating element can be eliminated. Furthermore, the electric heating sheet of the present invention can be mass produced.

3. Since the electric heating sheet of the present invention is in the form of a single woven layer, the heat conduction thereof is superior over that of the conventional electric heating element.

4. If a potential difference is present between two electric heating wires, an insulating thread can be arranged between the electric heating wires so as to eliminate the potential difference. As such, distance between the electric heating wires of the electric heating sheet can be reduced to 0.1-0.3 mm. As compared to the conventional electric heating element, the electric heating element of the present invention can provide a wiring area as much as about 3-5 times.

The present invention also permits reduction of the power load and an increase in the service life of the electric heating element.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A woven electric heating element comprising:
an electric heating sheet formed by weaving an electric heating wire and an insulating thread; and
two heat-resistant insulating layers covering respectively two opposite surfaces of said electric heating sheet.

2. The woven electric heating element of claim 1, wherein said electric heating wire is formed into a plurality of conductive warp lines, and said insulating thread is woven weftwise on said conductive warp lines.

3. The woven electric heating element of claim 2, further comprising a coarse insulating warp yarn disposed between two adjacent ones of said conductive warp lines, said insulating thread being a fine thread woven weftwise on said insulating warp yarn and said conductive warp lines.

4. The woven electric heating element of claim 2, further comprising two conductive clamp plates which are mounted respectively on two opposite ends of said electric heating sheet between said insulating layers to position respectively two opposite ends of each of said conductive warp lines.

5. The woven electric heating element of claim 4, wherein said electric heating sheet further includes an insulating warp yarn, said electric heating wire including two separate first and second heating wires, said first heating wire being formed into a plurality of conductive warp lines on one side of said insulating warp yarn, said second electric heating wire being formed into a plurality of conductive warp lines on the other side of said insulating warp yarn, one end of said first electric heating wire being connected to one end of said second electric heating wire.

6. A process for making a woven electric heating element, comprising:
weaving an electric heating wire with an insulating thread so as to form an electric heating sheet; and
covering two opposite surfaces of said electric heating sheet with two heat-resistant insulating layers, respectively.

7. The process for making a woven electric heating element of claim 6, wherein step (a) comprises warping said electric heating wire to form a plurality of conductive warp lines, and weaving weftwise said insulating thread on said conductive warp lines.

8. The process for making a woven electric heating element of claim 7, wherein said insulating thread is a fine thread, step (a) further comprising the step of disposing a coarse insulating warp yarn between two adjacent ones of said conductive warp lines.

9. The process for making a woven electric heating element of claim 6, further comprising the step of connecting two conductive clamp plates respectively to two opposite ends of said electric heating wire.

10. The process for making a woven electric heating element of claim 6, further comprising the steps of cutting said electric heating sheet into cut sections, and connecting said cut sections in parallel.

11. The process for making a woven electric heating element of claim 6, further comprising the steps of cutting said electric heating sheet into cut sections, and connecting said cut sections in series.
